(19) United States
(12) Patent Application Publication
(10) Pub. No.: US 2014/0334046 A1
(43) Pub. Date: Nov. 13, 2014

(54) SEMICONDUCTOR CIRCUIT

(71) Applicant: KABUSHIKI KAISHA TOSHIBA, Tokyo (JP)

(72) Inventors: Satoshi HARUKI, Kanagawa (JP); Kazuhiro KATO, Kanagawa (JP)

(73) Assignee: KABUSHIKI KAISHA TOSHIBA, Tokyo (JP)

(21) Appl. No.: 14/191,268

(22) Filed: Feb. 26, 2014

(30) Foreign Application Priority Data
May 13, 2013 (JP) 2013-101173

(51) Int. Cl. H02H 9/04

(52) U.S. Cl. CPC H02H 9/045
USPC 361/56

(57) ABSTRACT

A semiconductor circuit includes a clamp circuit and a switch circuit connected in series between a first power source terminal and a second power source terminal. The clamp circuit is configured to connect the first power source terminal to the second power source terminal when a voltage difference between the first and second power source terminals exceeds a threshold value. A control circuit controls the switch circuit such that the switch circuit is not conductive (open) when the voltage difference between the power source terminals is constant and is conductive (closed) when the voltage difference between the first and second power source terminals changes by more than a predetermined magnitude.

### CROSS-REFERENCE TO RELATED APPLICATION

This application is based upon and claims the benefit of priority from Japanese Patent Application No. 2013-101173, filed May 13, 2013, the entire contents of which are incorporated herein by reference.

### FIELD

Embodiments described herein relate generally to a semiconductor circuit which protects an internal circuit connected between power source lines from ESD surge.

### BACKGROUND

Various types of protection circuits providing protection from ESD (electrostatic discharge) have been proposed. ESD includes discharge from a human or machine charged by static electricity to a semiconductor device, discharge from a charged semiconductor device to the ground potential, and other types of discharge. When ESD occurs to a semiconductor device, a large current flow is produced from a corresponding terminal toward the semiconductor device. The surge of current generates a high voltage within the semiconductor device which may cause a dielectric breakdown of internal elements or other failure of the semiconductor device.

A protection element called RCT (RC triggered) MOS transistor includes a MOS transistor for voltage clamping the semiconductor device to a maximum voltage level is driven by an RC circuit as a triggering circuit.

According to the RCT MOS transistor, however, the RC circuit also responds to the surge of the power source voltage generated during the operation of an internal circuit connected between power source lines, and may turn on the MOS transistor even without the presence of ESD. In this case, problems may be caused such as generation of a so-called rush current which inhibits the intended rise of the power source voltage, and also an increase in the current consumption during device operation when the MOS transistor for clamping is inadvertently or mistakenly operated.

### DESCRIPTION OF THE DRAWINGS

FIG. 1 is a block diagram of a first embodiment.

FIG. 2 illustrates an exemplary structure of the first embodiment.

FIG. 3 is a block diagram of a second embodiment.

FIG. 4 illustrates an exemplary structure of the second embodiment.

### DETAILED DESCRIPTION

In general, according to one embodiment, it is an object to provide a semiconductor circuit capable of preventing malfunction of a clamp circuit for ESD protection.

In an embodiment, a semiconductor circuit comprises a clamp circuit and a switch circuit connected in series between a first power source terminal and a second power source terminal. The clamp circuit is configured to connect the first power source terminal to the second power source terminal when a voltage difference between the first and second power source terminals exceeds a predetermined threshold value. For example, when an ESD causes a voltage surge, the clamp circuit acts to dissipate the surge. A control circuit is configured to control a conductance state of the switch circuit between an ON and an OFF conductance state. In the ON conductance state the main current path of the switch circuit is conductive and in the OFF conductance state the main current path of the switch circuit is non-conductive. The control circuit controls the switch circuit such that the switch circuit is in the OFF conductance state when the voltage difference between the first and second power source terminals is constant (not changing) and the switch circuit is in an ON conductance state when a change in the voltage difference between the first and second power source terminals exceeds a predetermined magnitude.

According to one embodiment, a semiconductor circuit includes a first power source terminal to which a first power source voltage is applied, a first power source line connected with the first power source terminal, a second power source terminal to which a second power source voltage is applied, and a second power source line connected with the second power source terminal. The semiconductor circuit includes an internal circuit connected between the first power source line and the second power source line. The semiconductor circuit includes a clamp circuit connected in series between the first power source line and the second power source line via at least one switch unit. The semiconductor circuit includes a control circuit supplying to the switch unit a control signal for controlling on-off of the switch unit.

A semiconductor circuit according to exemplary embodiments is hereinafter described in detail in conjunction with the accompanying drawings. These embodiments are presented by way of example only, and do not impose any limitations on the intended scope of this disclosure.

### First Embodiment

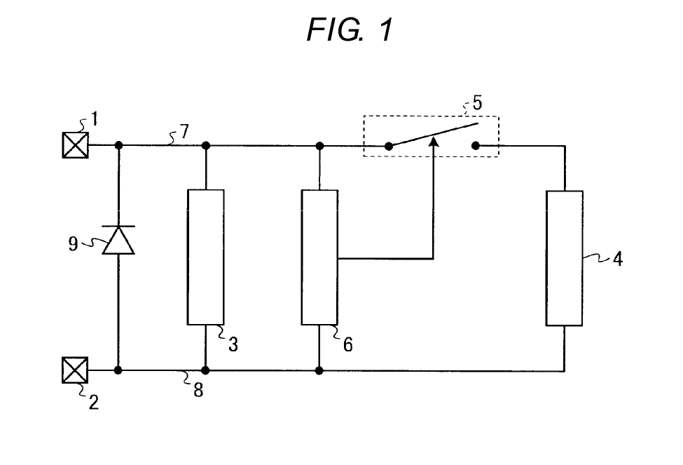

FIG. 1 is a block diagram of a semiconductor circuit according to a first embodiment. The semiconductor circuit in this embodiment includes a first power source terminal 1 to which a high potential side power source voltage is applied as a first power source voltage. In a steady-state condition, a voltage of 5V, for example, may be applied to the first power source terminal 1. The ground potential, for example, as a low potential side voltage is applied to a second power source terminal 2. A high potential side first power source line 7 is connected to the first power source terminal 1. A low potential side second power source line 8 is connected to the second power source terminal 2.

An internal circuit 3 is connected between the first power source line 7 and the second power source line 8 and is biased by a voltage between the first power source line 7 and the second power source line 8 and performs predetermined circuit operation.

A clamp circuit 4 is a circuit for protecting the internal circuit 3 from an ESD surge. The clamp circuit 4 is connected in series with a switch unit 5 between the first power source line 7 and the second power source line 8.

The on-off state of the switch unit 5 is controlled in accordance with a control signal generated from a control circuit 6 connected between the first power source line 7 and the second power source line 8.

The cathode electrode of an ESD protection diode 9 is connected to the first power source line 7, while the anode electrode of the ESD protection diode 9 is connected to the second power source line 8. When the ESD surge is applied to the power source terminal 2, the ESD protection diode 9 is conductive and discharges the ESD surge. The ESD protection diode 9 is optional in this embodiment and may be eliminated.

In the steady condition, the control circuit 6 outputs the control signal for turning off the switch unit 5. More specifically, when a predetermined voltage for allowing operation of the internal circuit 3, such as 5V, is applied between the first power source terminal 1 and the second power source terminal 2, the switch unit 5 is turned off. When the switch unit 5 is in an off state (non-conductance state), the first power source line 7 and the clamp circuit 4 are disconnected from each other. This prevents transmission of a voltage surge generated between the first power source line 7 and the second power source line 8 to the clamp circuit 4, that is, this disconnection can prevent malfunction of the clamp circuit 4 caused by the voltage surge. Accordingly, this structure prevents problems such as the inhibition of an intended rise in the power source voltage, and an increase in the current consumption caused by unintended or unnecessary operation of the clamp circuit 4.

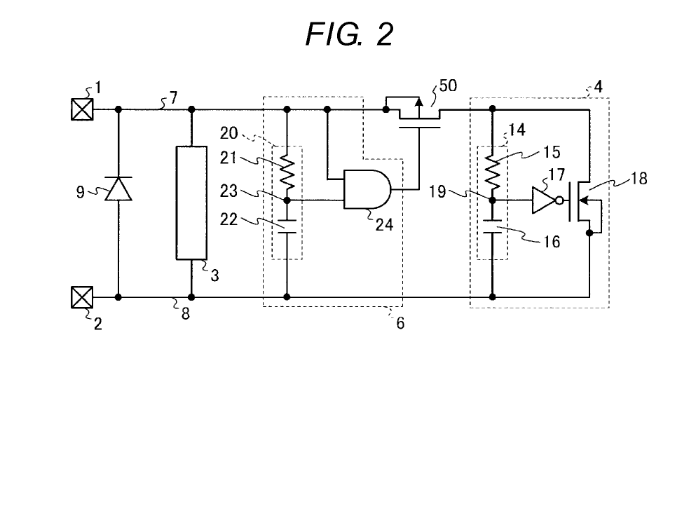

FIG. 2 illustrates an example of a specific structure of the first embodiment. The elements in FIG. 2 corresponding to the elements in FIG. 1 are given the same reference numbers, and the associated explanation may not be repeated.

One end of the clamp circuit 4 is connected to one end of a p-channel metal-oxide-semiconductor (PMOS) transistor 50, which forms the switch unit 5. The other end of the PMOS transistor 50 is connected to the first power source line 7. Thus, the one end of the clamp circuit 4 is connected to the first power source line 7 via a source-drain channel of the PMOS transistor 50. The source drain-channel corresponds to a main current channel of the PMOS transistor 50. The other end of the clamp circuit 4 is connected to the second power source line 8.

According to this structure, the clamp circuit 4 is connected in series with the PMOS transistor 50 between the first power source line 7 and the second power source line 8. The clamp circuit 4 includes a first RC circuit 14 constituted by a series circuit of a first resistor 15 and a first capacitor 16. That is, first resistor 15 and first capacitor 16 are connected in series with each other. The clamp circuit 4 further includes an inverter 17 having input connection (e.g., terminal or electrode) connected to a first common node 19 (output end of the first RC circuit 14) to which the first resistor 15 and the first capacitor 16 are connected.

The clamp circuit 4 further includes an NMOS transistor for clamping (hereinafter referred to as NMOS clamp transistor) 18. The source-drain channel of the NMOS clamp transistor 18 is connected in parallel with the first RC circuit 14 between first power source line 7 and second power source line 8. The output of the inverter 17 is applied to the gate electrode of the NMOS clamp transistor 18.

According to this embodiment, therefore, the conductance state of NMOS clamp transistor 18 is controlled by the first RC circuit 14. In this embodiment, the inverter 17 is provided between the first RC circuit 14 and the gate electrode of the NMOS clamp transistor 18. The specific structure of inverter 17 is not limited to the structure depicted in FIG. 2. A circuit or connection between RC circuit 14 and the gate electrode of the NMOS clamp transistor 18 is not limited to an inverter 17 but may be any circuit of any type as long as a correct logic is output to control NMOS claim transistor 18. Similar modifications to the corresponding structure of a second embodiment, described below, may also be made.

The control circuit 6 includes a second RC circuit 20 formed by a second resistor 21 and a second capacitor 22 connected in series between the first power source line 7 and the second power source line 8. The control circuit 6 further includes an AND circuit 24 having two input ends (e.g., terminals). A first input end of the AND circuit 24 is connected to a second common node 23 (output end of the second RC circuit 20) to which the second resistor 21 and the second capacitor 22 are connected. A second input end of the AND circuit 24 is connected to the first power source line 7. An output end (e.g., terminal) of the AND circuit 24 is connected to the gate (control) electrode of the PMOS transistor 50.

The potential of the power source lines corresponds to the potential applied to the respective power source terminals. That is, when a 5V potential is applied to the first power source terminal 1 and the ground potential is applied to the second power source terminal 2, the potential of the first power source line 7 becomes 5V. The potential at the second common node 23 of the second RC circuit 20 of the control circuit 6 also becomes 5V. In this case, a HIGH level voltage (signal) is input to both the first and second input ends of the AND circuit 24, wherefore the AND circuit 24 supplies a HIGH level output signal to the gate electrode of the PMOS transistor 50. As a result, the PMOS transistor 50 is turned off, creating high impedance between the first power source line 7 and the clamp circuit 4. This condition can prevent transmission of voltage surge generated between the first power source line 7 and the second power source line 8 to the clamp circuit 4, that is, can avoid malfunction of the clamp circuit 4 caused in response to an increase in the power source voltage. Accordingly, this structure is effective in preventing problems such as a condition inhibiting rise of the power source voltage, and increase in the current consumption produced as a result of malfunction of the clamp circuit 4.

On the other hand, when ESD surge is applied to the first power source terminal 1 while no power source voltage is applied between the first power source terminal 1 and the second power source terminal 2, the first RC circuit 20 responds to the ESD surge and allows transient flow of current between the first power source terminal 1 and the second power source terminal 2. This current flow generates a voltage drop across the second resistor 21 of the second RC circuit 20. In response to the voltage drop across the second resistor 21, a LOW level signal is input to the first input end of the AND circuit 24. On the other hand, HIGH level is inputted to the second input end of the AND circuit 24, wherefore the output of the AND circuit 24 becomes LOW level.

When a LOW level control signal is applied to the gate electrode of the PMOS transistor 50, the PMOS transistor 50 is turned on (on conductance state). When the PMOS transistor 50 is in the on conductance state, the clamp circuit 4 is connected to the first power source line 7 with low impedance. As a result, the first RC circuit 14 of the clamp circuit 4 responds to the voltage between the first power source line and the second power source line 8, whereby current transiently flows between the first power source line 7 and the second power source line 8 via the first RC circuit 14. This current generates a voltage drop across the first resistor 15 of the first RC circuit 14.

When the potential at the first common node 19 becomes a value equal to or lower than the threshold of the inverter 17 by the voltage drop thus generated, a HIGH level output signal is supplied from the inverter 17 to the gate electrode of the NMOS clamp transistor 18. The supply of the HIGH level signal to the gate electrode of the NMOS clamp transistor 18 turns on the NMOS clamp transistor 18 and allows discharge of ESD surge through the NMOS clamp transistor 18.

When an ESD surge is applied to the second power source terminal 2, the ESD protection diode 9 is turned on and allows discharge of ESD surge.

### Second Embodiment

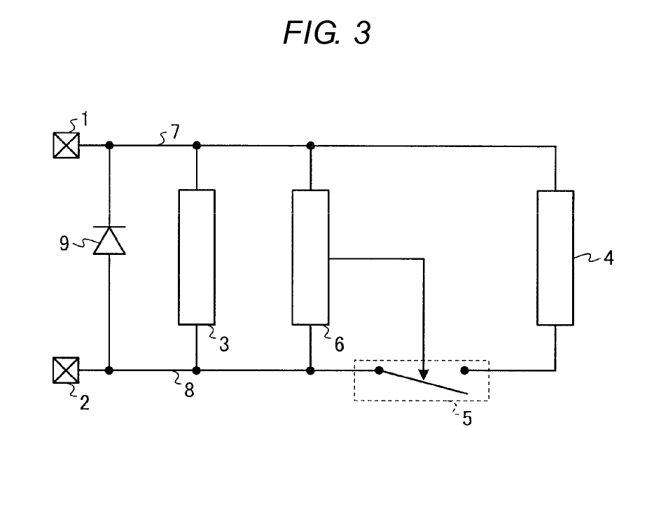

FIG. 3 is a block diagram of a second embodiment. The elements similar to the elements of already described embodiments are given the same reference numbers, and the explanation of these elements may not be repeated.

According to this second embodiment, the switch unit 5 is disposed on the second power source line 8 side corresponding to the low potential side. In the steady-state operating condition, the control circuit 6 supplies a control signal for turning off the switch unit 5. More specifically, in the steady-state condition, constant voltages are supplied for allowing operation of the internal circuit 3 connected between the first power source terminal 1 and the second power source terminal 2. For example a 5V potential may be applied to the first power source terminal 1 and the ground potential to the second power source terminal 2. In this steady-state condition, the switch unit 5 is turned off. When the switch unit 5 is in an off conductance state, the clamp circuit 4 and the second power source line 8 are disconnected from each other. This condition can prevent transmission of a voltage surge generated between the first power source line 7 and the second power source line 8 to the clamp circuit 4, that is, can avoid malfunction of the clamp circuit 4 caused by a surge of the power source voltage. Accordingly, this structure is effective in preventing problems such as an inhibition in an intended rise of the power source voltage, and an increase in current consumption when the clamp circuit 4 is erroneously operated.

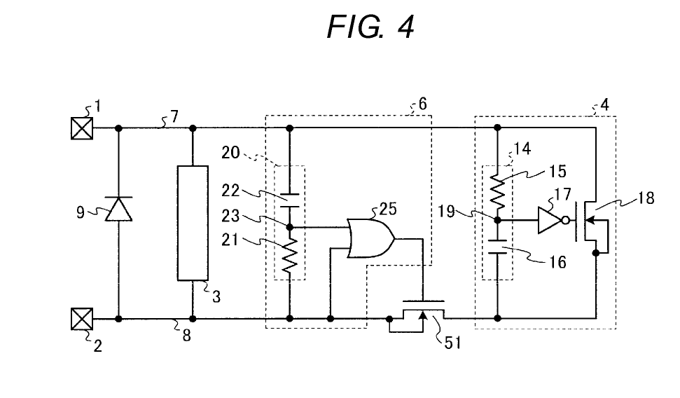

FIG. 4 illustrates an example of a specific structure of the second embodiment. The elements corresponding to the elements in the already described embodiments are given the same reference numbers, and explanation of repeated elements may not be repeated.

The control circuit 6 includes the second RC circuit 20 connected between the first power source line 7 and the second power source line 8. The second RC circuit 20 is formed the second capacitor 22 and the second resistor 21 connected in series.

The control circuit 6 further includes an OR circuit 25 having two input ends (e.g., terminals). A first input end of the OR circuit 25 is connected to the second common node 23 (output end of the second RC circuit 20) to which the second resistor 21 and the second capacitor 22 of the second RC circuit 20 are connected. A second input end of the OR circuit 25 is connected with the second power source line 8. The source electrode of an NMOS transistor 51 forming the switch unit 5 is connected to the second power source line 8. An output end (terminal) of the OR circuit 25 is supplied to the gate (control) electrode of the NMOS transistor 51

One end of the clamp circuit 4 is connected to the drain electrode of the NMOS transistor 51. According to this structure, the source-drain channel of the NMOS transistor 51 is connected between the second power source line 8 and the clamp circuit 4. The other end of the clamp circuit 4 is connected to the first power source line 7. Thus, the clamp circuit 4 is connected in series with the NMOS transistor 51 between the first power source line 7 and the second power source line 8.

In the steady-state condition, i.e., when predetermined power source voltages are applied, such as 5V for the first power source terminal 1 and the ground potential for the second power source terminal 2, the potential of the second power source line 8 becomes 0V. Similarly, the potential at the second common node 23 of the second RC circuit 20 of the control circuit 6 becomes the ground voltage, i.e., 0V. In this case, a LOW level signal (voltage) is inputted to each of the first and second input ends of the OR circuit 25, wherefore the OR circuit 25 supplies a LOW level signal to the gate electrode of the NMOS transistor 51. As a result, the NMOS transistor 51 is turned off, creating high impedance between the second power source line 8 and the clamp circuit 4. This prevents the transmission of a voltage surge generated between the first power source line 7 and the second power source line 8 to the clamp circuit 4. Accordingly, this structure is effective in preventing problems such inhibition of an intended rise of the power source voltage, and an increase in the current consumption when the clamp circuit 4 is erroneously operated.

On the other hand, when ESD surge positive for the second power source terminal 2 is applied to the first power source terminal 1, the second RC circuit 20 of the control circuit responds to the ESD surge and allows current to flow transiently between the first power source terminal 1 and the second power source terminal 2. This current flow generates a voltage drop across the second resistor 21 of the second RC circuit 20.

In response to the voltage drop across the second resistor 21, a HIGH level signal (voltage) is input to the first input end of the OR circuit 25. A LOW level signal (voltage) is input to the second input end of the OR circuit 25; wherefore the output of the OR circuit 25 becomes HIGH level.

When a HIGH level control signal is applied to the gate electrode of the NMOS transistor 51, the NMOS transistor 51 is turned on (i.e., the source-drain path is placed in an on conductance state). In response to the on condition of the NMOS transistor 51, the clamp circuit 4 is connected to the second power source line 8 with low impedance. As a result, the first RC circuit 14 of the clamp circuit 4 responds to the voltage difference between the first power source line 7 and the second power source line 8, whereby current transiently flows between the first power source line 7 and the second power source line 8 via the first RC circuit 14. This current generates a voltage drop across the first resistor 15 of the first RC circuit 14.

When the potential at the first common node 19 becomes a value equal to or lower than the threshold of the inverter 17 by the voltage drop thus generated across the first resistor 15 of the first RC circuit 14, a HIGH level output signal is supplied from the inverter 17 to the gate electrode of the NMOS clamp transistor 18.

The supply of the HIGH level signal to the gate electrode of the NMOS clamp transistor 18 turns on the NMOS clamp transistor 18 and allows discharge of ESD surge current. When ESD surge is applied to the second power source terminal 2, the ESD protection diode 9 is turned on and allows discharge of ESD surge.

While examples which include MOS (metal-oxide-semiconductor) transistors functioning as switch transistors is discussed in the respective embodiments, a structure which contains bi-polar transistors can be employed. In the case of the structure containing bi-polar transistors, the main current channel corresponds to the emitter-collector channel, while the control electrode corresponds to the base electrode. In this case, NPN transistors may be used in place of the NMOS transistors in view of the bias condition.

Moreover, such structure may be employed that includes switch units in both the power source line on the high potential side and in the power source line on the low potential side, such as in a combination of the first and second embodiments within one device.

While certain embodiments have been described, these embodiments have been presented by way of example only, and are not intended to limit the scope of the inventions. Indeed, the embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor circuit, comprising:
a clamp circuit and a switch circuit connected in series between a first power source terminal and a second power source terminal, the clamp circuit configured to connect the first power source terminal to the second power source terminal when a voltage difference between the first and second power source terminals exceeds a predetermined threshold value; and
a control circuit configured to control a conductance state of the switch circuit such that the switch circuit is in an OFF conductance state when the voltage difference between the first and second power source terminals is constant and the switch circuit is in an ON conductance state when a change in the voltage difference between the first and second power source terminals exceeds a predetermined magnitude.

2. The semiconductor circuit of claim 1, wherein the switch circuit is between the clamp circuit and the first power source terminal.

3. The semiconductor circuit of claim 1, wherein the switch circuit is between the clamp circuit and the second power source terminal.

4. The semiconductor circuit of claim 1, further comprising:
a diode connected between the first and second power source terminals.

5. The semiconductor circuit of claim 1, wherein the control circuit includes a resistor and a capacitor connected in series between the first and second power source terminals.

6. The semiconductor circuit of claim 5, wherein
the switch circuit includes a p-channel metal-oxide-semiconductor (PMOS) transistor with a source-drain path connected between the first power source terminal and the clamp circuit, and
the control circuit includes an AND logic circuit with a first input terminal connected to the first power source terminal and a second input terminal connected to a connection node between the resistor and the capacitor, and an output terminal of the AND logic circuit is connected to a gate electrode of the PMOS transistor.

7. The semiconductor circuit of claim 5, wherein
the switch circuit includes a n-channel metal-oxide-semiconductor (NMOS) transistor with a source-drain path connected between the second power source terminal and the clamp circuit, and
the control circuit includes an OR logic circuit with a first input terminal connected to the second power source terminal and a second input terminal connected to a connection node between the resistor and capacitor, and an output terminal of the OR logic circuit is connected to a gate electrode of the NMOS transistor.

8. The semiconductor circuit of claim 1, wherein the switch circuit includes a n-channel metal-oxide-semiconductor (NMOS) transistor.

9. The semiconductor circuit of claim 1, wherein the switch circuit includes a p-channel metal-oxide-semiconductor (PMOS) transistor.

10. The semiconductor circuit of claim 1, wherein the clamp circuit comprises:
a resistor and capacitor connected in series between the first and second power source terminals;
a n-channel metal-oxide-semiconductor (NMOS) transistor having a source-drain path connected in parallel with the series-connected resistor and capacitor; and
a buffer circuit connected between a connection node between the resistor and the capacitor and a gate electrode of the NMOS transistor.

11. The semiconductor circuit of claim 10, wherein the buffer circuit is an inverter.

12. A semiconductor circuit, comprising:
a first resistor and a first capacitor connected in series between a first power source terminal and a second power source terminal;
a first transistor having a main current path connected between the first and second power source terminals;
an inverter circuit having an input end connected to a first connection node between the first resistor and the first capacitor and an output end connected to a control electrode of the first transistor;
a second transistor having a main current path connected between the first and second power source terminals in series with the main current path of the first transistor;
a second resistor and a second capacitor connected in series between the first power source terminal and the second power source terminal; and
a logic circuit having a first input terminal connected to a second connection node between the second resistor and the second capacitor and a second input terminal connected to one of the first and second power source terminals, an output terminal of the logic circuit connected to a control electrode of the second transistor.

13. The semiconductor circuit of claim 12, further comprising:
a diode connected between the first and second power source terminals.

14. The semiconductor circuit of claim 12, wherein
the second resistor is between the first power source terminal and the second connection node,
the second transistor is between the first power source terminal and the first transistor,
the second input terminal of the logic circuit is connected to the first power source terminal,
the second transistor is a p-channel metal-oxide-semiconductor (PMOS) transistor, and
the logic circuit is an AND circuit.

15. The semiconductor circuit of claim 14, wherein the first transistor is a n-channel metal-oxide-semiconductor (NMOS) transistor.

16. The semiconductor circuit of claim 12, wherein
the second resistor is between the second power source terminal and the second connection node,
the second transistor is between the second power source terminal and the first transistor,
the second input terminal of the logic circuit is connected to the second power source terminal,
the second transistor is a n-channel metal-oxide-semiconductor (NMOS) transistor, and
the logic circuit is an OR circuit.

17. The semiconductor circuit of claim 16, wherein the first transistor is a NMOS transistor.

18. A semiconductor device, comprising:
an internal circuit connected between a first power source terminal and a second power source terminal and configured to perform a predetermined circuit operation when a first potential is supplied to the first power source terminal and a second potential is supplied to the second power source terminal;
a clamp circuit and a first switch circuit connected in series between the first and second power source terminals, the clamp circuit configured to connect the first power source terminal to the second power source terminal when a voltage difference between the first and second power source terminals exceeds a predetermined threshold value; and
a control circuit configured to control a conductance state of the first switch circuit such that the first switch circuit is in an OFF conductance state when the voltage difference between the first and second power source terminals is constant and the first switch circuit is in an ON conductance state when a change in the voltage difference between the first and second power source terminals exceeds a predetermined magnitude.

19. The semiconductor device of claim 18, further comprising:
a second switch circuit connected in series with the clamp circuit and the first switch circuit between the first and second power source terminal, wherein
the first switch circuit is between the first power source terminal and the clamp circuit,
the second switch circuit is between the second power source terminal and the clamp circuit, and
the control circuit is further configured to a conductance state of the second switch circuit such that the second switch circuit is in an OFF conductance state when the voltage difference between the first and second power source terminals is constant and the second switch circuit is in an ON conductance state when a change in the voltage difference between the first and second power source terminals exceeds the predetermined magnitude.

20. The semiconductor device of claim 18, wherein
the clamp circuit includes:
a first resistor and a first capacitor connected in series between the first power source terminal and the second power source terminal,
a first transistor having a main current path connected between the first and second power source terminals, and
a buffer circuit having an input end connected to a first connection node between the first resistor and the first capacitor and an output end connected to a control electrode of the first transistor
the switch circuit includes:
a second transistor having a main current path connected between the first and second power source terminals in series with the main current path of the first transistor; and
the control circuit includes:
a second resistor and a second capacitor connected in series between the first power source terminal and the second power source terminal, and
a logic circuit having a first input terminal connected to a second connection node between the second resistor and the second capacitor and a second input terminal connected to one of the first and second power source terminals, an output terminal of the logic circuit connected to a control electrode of the second transistor.
